(19) United States
(12) Patent Application Publication
(10) Pub. No.: US 2013/0268855 A1
(43) Pub. Date: Oct. 10, 2013

(54) EXAMINING AN EXECUTION OF A BUSINESS PROCESS

(71) Applicant: JOHN O'BYRNE, Santa Clara, CA (US)

(72) Inventor: JOHN O'BYRNE, Santa Clara, CA (US)

(21) Appl. No.: 13/442,884

(22) Filed: Apr. 10, 2012

(51) Int. Cl. G06F 3/048; G06F 17/30

(52) U.S. Cl. 715/711; 715/771

(57) ABSTRACT

From a computer generated user interface (UI), a selection of a UI element representing a corresponding business process element is received. The metadata of the selected UI element is retrieved from a database to determine associated business process elements. The associated business process elements are determined by identifying a lineage of an input to the business process element corresponding to the selected UI element, identifying a lineage of an output from the business process element corresponding to the selected UI element, and identifying a lineage of a transformation of data associated with the business process element corresponding to the selected UI element. Based upon the determination of the associated business process elements a visual representation of the dataflow involved in executing the business process is rendering on the computer generated UI.

### TECHNICAL FIELD

The field generally relates to computer systems and software, and more particularly to software methods and systems to examine execution of business processes.

### BACKGROUND

Data management relates to managing digital data of a group of business enterprises. Data management promotes effectiveness and efficiency of business processes that are carried out using the digital data. Business process management may be described as a part of data management that is responsible for aligning the business data of the enterprise with a business requirement. Data warehousing relates to reporting and analyzing the business data of the business process associated with a corresponding enterprise. The business data may be extracted from external sources, transformed to comply with operational needs of the associated enterprise, and loaded to a target data warehouse. This process is typically known as “Extract, Transform and Load” (ETL), and a tool that implements such process may be referred to as an ETL tool.

Monitoring the ETL processes includes tracking of individual processes associated with the business data that are involved in achieving an end result. Tracking of business process is useful in understanding business logics involved in executing the process and in establishing corresponding business decisions. However, the process of tracking involves analyzing enormous amount of business data, and presenting this enormous business data for intended business usage. Hence, using the tracked massive business data to comprehend the execution of the business process is useful.

### SUMMARY

Various embodiments of systems and methods to examine a dataflow in an execution of a business process are disclosed. A business process includes a collection of actions that produce a desired output upon execution. The actions are associated with business data that represent the business process under consideration. The business data includes factual information about a corresponding business, using which a conclusion of the business may be established. A dataflow may represent a flow of the business data within an associated system configured to perform the execution of the business process. During the execution of the business process, the data involved may be transferred from one data component to another, or may undergo many transformations.

In an embodiment, a computer generated user interface (UI) provides a platform to examine the flow of data during the execution of the business process. For instance, the UI renders elements involved in the business process. Each element of the business process may be represented as a UI element. These UI elements are associated with data components such as a data source, a data destination, a data transformation unit, or the like, that are involved in the execution of the business process. Based upon a selected UI element, a processor associated with the computer determines the flow of data corresponding to the business process element associated with the selected UI element. The flow of data involved during the execution of the business process is further rendered on the UI as a visual representation. By examining the flow of this data involved in the execution of the business process, comprehensive business decisions may be established.

These and other benefits and features of embodiments of the invention will be apparent upon consideration of the following detailed description of the embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an overview of a system to examine a dataflow in an execution of a business process, according to an embodiment.

FIG. 2 is a block diagram illustrating an overview of a system to examine a dataflow in an execution of a business process, according to an embodiment.

FIG. 3 is a computer generated user interface illustrating a dataflow in an execution of a business process, according to an embodiment.

FIG. 4 is a computer generated user interface illustrating a dataflow in an execution of a business process, according to an embodiment.

FIG. 5 is a process flow diagram illustrating a computer-implemented method to examine a dataflow in an execution of a business process, according to an embodiment.

FIG. 6 is a block diagram illustrating a computer system to examine a dataflow in an execution of a business process, according to an embodiment.

FIG. 7 is a block diagram illustrating an exemplary computer system, according to an embodiment.

### DETAILED DESCRIPTION

Embodiments of techniques for systems and methods to examine an execution of a business process are disclosed herein.

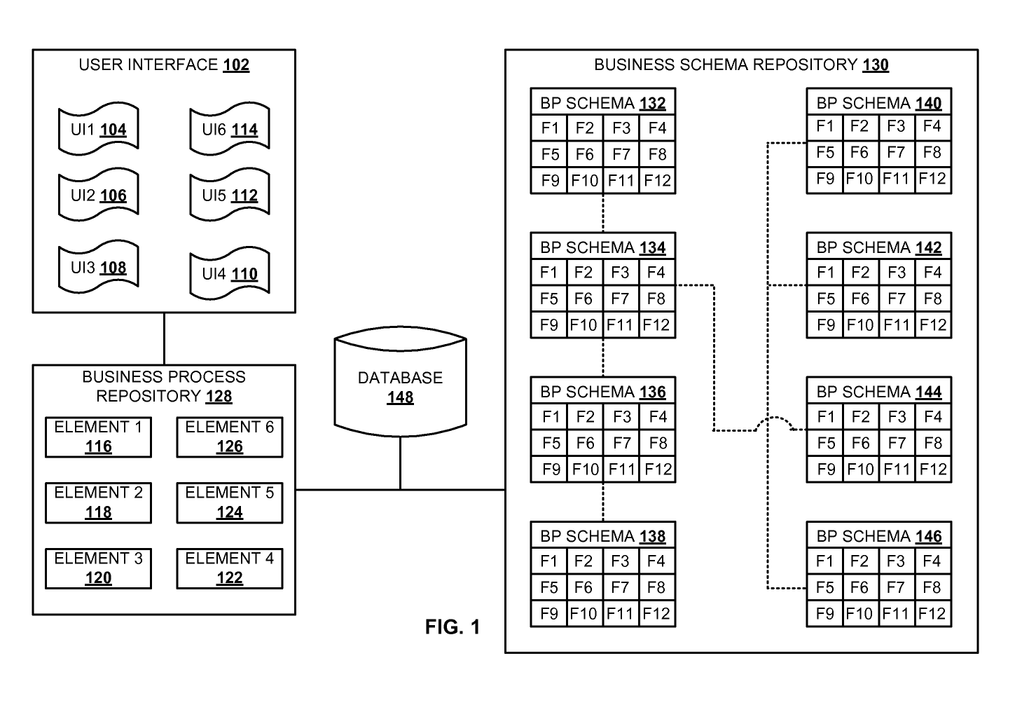

FIG. 1 is a block diagram illustrating an overview of a computer system to examine a dataflow in an execution of a business process, according to an embodiment. A business process includes a collection of actions or tasks that produce a desired output upon execution. Examining a dataflow includes analyzing a flow of data in the execution of a business process. An execution of a business process includes carrying out one or more instructions related to business components associated with the business process, to achieve a desired output. The business components may include, but are not limited to, business process elements, database schemas, business database tables, data fields, data rows, data columns or the like, that include information about a corresponding business, and associated actions that are executed to complete the execution of the business process. The business process elements are business entities that include business information corresponding to the business process. The business process elements may comprise an action or a task associated with a business process, and represent backend information of a corresponding user interface element present on a user interface. The business process element may contain business rules, business logics, mathematical formulae, data transformations, and the like, that are associated with executing the business process. To execute the business process, the business process elements are executed, and hence, the business process elements behave as subsets of the business process.

The business components including business process elements and associated actions are stored in a backend data holder, for example, a database. Database schemas may be considered as internal representations of the business data in the business process elements. The data fields may represent columns or rows of a table that store the business data. Whenever the information is accessed, extracted, transformed, or loaded from one component to another, a processor tracks the flow of information, and updates the database accordingly. Thus, the business information associated with the business process may undergo transformation while traversing from a source data component to a destination data component. Tracking the flow of information helps in determining concatenations of business components, modifications performed on the information associated with the business components, modifications performed on names or locations of the business components, filtering of information or the like. For instance, consider a water pipe connected to a water faucet (source), to carry water to a water tank (destination). The flow of information is comparable to the flow of water through the water pipe; and the business component is comparable to a filter present at intermediate levels of the water pipe, before the water reaches the water tank. The business component behaves as a filter, where the input to the component may be transformed before it moves to a next component. Tracking the flow of information from the source to the destination is beneficial to analyze developments of the information (e.g. transformations) involved, and to make business decisions. Visually displaying the lineage associated with the execution the business process identifies the business components involved in the execution. The terms ‘database schema’ and ‘business process schema’ may be used interchangeably throughout the specification.

In an embodiment, the business process elements associated with an execution of a business process are rendered on user interface (UI) 102 as UI elements. For instance, business process elements 116, 118, 120, 122, 124 and 126 persisted in business process repository 128 have corresponding UI elements 104, 106, 108, 110, 112, and 114 rendered on UI 102. Business schema repository 130 represents business process schemas 132, 134, 136, 138, 140, 142, 144 and 146 associated with business process elements 116, 118, 120, 122, 124 and 126. Business process schemas have data fields F1 to F12 to store data accordingly. Business schema repository 130 also represents one or more correlations between one or more business process schemas. The correlations may be represented by dotted lines connecting two or more business process schemas. Database 148 stores the information or the business data associated with elements, the schemas, and the fields. A user is provided with UI elements 104, 106, 108, 110, 112, and 114 on UI 102, to select one or more UI elements associated with the execution of the business process for analysis. Based upon a selection of a UI element on UI 102, a UI engine in communication with UI 102 determines a corresponding business process element for the selected UI, and transmits the selection of the UI element and the determined business process element to a processor of the computer to retrieve metadata of the selected UI element from database 148. The metadata of the selected UI element includes the business information required to execute the business process, including information about corresponding business process elements, business process schemas and associated data fields. Business information includes business logic, business rules, mathematical formulae and the like, that are required to execute the business process. Based upon the selected UI element, the corresponding business process element and the associated metadata, one or more business process elements that are correlated to the selected UI and/or its corresponding business process element are determined.

To determine the other correlated business process elements, input to the selected UI element and/or its corresponding business process element, output from the selected UI element and/or its corresponding business process element, and one or more transformations of the data associated with the selected UI element and/or its corresponding business process element are identified. Identifying an input to the selected UI element and/or its corresponding business process element includes identifying a lineage of the input. A lineage of an input includes an ancestry of the input, from its origin to the selected UI element and/or its corresponding business process. Identifying a lineage of a UI element includes identifying a provenance of the corresponding UI element, identifying a chronology of usage of associated information, identifying a chronology of location of the information, and the like. Identifying the lineage of the input to the selected UI element and/or its corresponding business process includes determining a source of the input, one or more ramifications from the source into corresponding one or more intermediate data components, one or more output of such intermediate data components, and the like, until it reaches the selected UI and/or its corresponding business process.

Identifying an output of the selected UI element and/or its corresponding business process elements includes identifying a lineage of the output. A lineage of the output includes a posterity or one or more descendants of the output, from the selected UI element and/or its corresponding business process to one or more intermediate data components and finally to its destination, to complete the execution of the business process. Identifying the lineage of the output from the selected UI element and/or its corresponding business process elements includes determining one or more ramifications of the output and a destination where the execution of the business process is completed.

Identifying a transformation of the data associated with the selected UI element and/or its corresponding business process element includes identifying a lineage of the transformation of data. A lineage of the transformation includes an ancestry of the data associated with the selected UI element and/or its corresponding business process elements, a posterity of the data associated with the selected UI element and/or its corresponding business process elements, and one or more transformation of the data associated with the selected UI element and/or its corresponding business process elements. During the execution of the business process, the data and its corresponding attributes present in the selected UI element and the correlated UI elements involved in the execution may be accessed, shared and transformed accordingly. Attributes of the data may include various properties of the data, details about the data, and the like. For instance, a data source may provide textual business information to an intermediate UI element that precedes the selected UI element. In the preceding intermediate UI element, the information may be transformed into mathematical functions. These mathematical functions may be provided as the input to the selected UI element. Further, the mathematical functions may undergo another transformation into numeric information in the selected UI element. This numeric information may be further transmitted to a succeeding UI element, and then finally to the destination. Identifying the lineage of the transformation comprises identifying all the attributes associated with the data, including the textual information at the source, the mathematical functions at the intermediate data components, the numeric information, the transformation in a succeeding UI element and the information transmitted to the destination.

The lineage of the input, output and the transformation of the data represent the correlation between the selected UI element and its corresponding business process, and the other UI elements and their corresponding business processes. In an embodiment, the selected UI element and/or its corresponding business process exists in a hierarchy. Here, the lineages of the input to the selected UI element from one or more preceding UI elements, the lineage of the output from the selected UI element to one or more succeeding UI elements, and the lineage of the transformation data associated with the preceding and the succeeding UI elements are identified. Based upon the lineages, one or more UI elements that are correlated to the selected UI element are determined. This includes determining one or more business process elements that are correlated to the business process element corresponding to the selected UI element.

Upon the determination of the correlated business process elements, a visual representation of the dataflow involved in executing the business process is rendered on the UI. Visually representing the lineage includes highlighting one or more correlations between the selected UI element and the correlated UI elements. Highlighting the correlation includes highlighting the correlated UI elements, and highlighting a dataflow between the correlated UI elements. In an embodiment, a tooltip is rendered along with the correlated UI elements, to provide a summary of the information associated with a corresponding correlated UI element. The tooltip may include information about the correlated business elements, the transformations associated with the information, a history of the information, a source of the information, and the like. The tooltip may also display a summary of the business process and the execution of the business process.

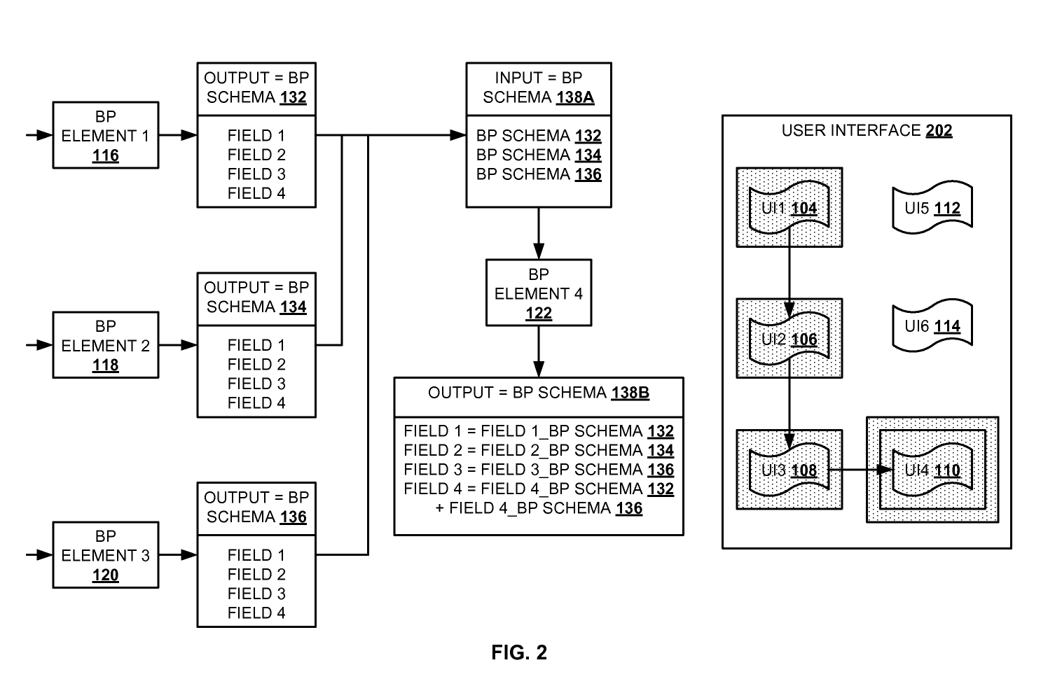

For instance consider FIG. 2, which is a block diagram illustrating an overview of a system to examine a dataflow in an execution of a business process, according to an embodiment. UI 101 of FIG. 1 included a set of UI elements, irrespective of their involvement in the execution of the business process. FIG. 2 includes UI 202 that represents a resultant of the examination of the dataflow in the execution of the business process. FIG. 2 includes business process element 122 of selected UI element 110. The lineage of the input to business process element 122, represented by input business process schema 138A, includes business process schema 132, business process schema 134 and business process schema 136, representing three ramifications of data merging at input business process schema 138A. The lineage of the transformation of data associated with business process element 122 includes the fields associated with the corresponding business process schemas 132, 134 and 136, which are the corresponding output of business process elements 116, 118 and 120 respectively. These fields (F1, F2, F3, F4 of business process schema 132; F1, F2, F3, F4 of business process schema 134; and F1, F2, F3, F4 of business process schema 136) include correlated data, from corresponding business process elements, which have originated from a common data source. The lineage of the output from business process element 122 is represented by output business process schema 138B, which is a destination component in the execution of the business process.

In an embodiment, output business process schema 138B represents one or more fields from correlated business process schemas that are associated with it. For instance, field 1 of output business process schema 138B is extracted and loaded from field 1 of output business process schema 132; field 2 of output business process schema 138B is extracted and loaded from field 2 of output business process schema 134; field 3 of output business process schema 138B is extracted and loaded from field 3 of output business process schema 136; and field 4 of output business process schema 138B is extracted and loaded from a concatenation of field 4 of output business process schema 132 and field 4 of output business process schema 136. This illustrates the correlation between the business process elements 116, 118 and 120 with business process element 122 of selected UI element 110. Thus the correlated business process elements are determined. Based upon the determination of the correlation, a visual representation of the dataflow is rendered on UI 202. UI 202 includes a shaded area around the correlated UI elements corresponding to the correlated business process elements associated with selected UI element 110. UI 202 also includes an indication of the direction of the flow of data, represented by arrow-headed lines.

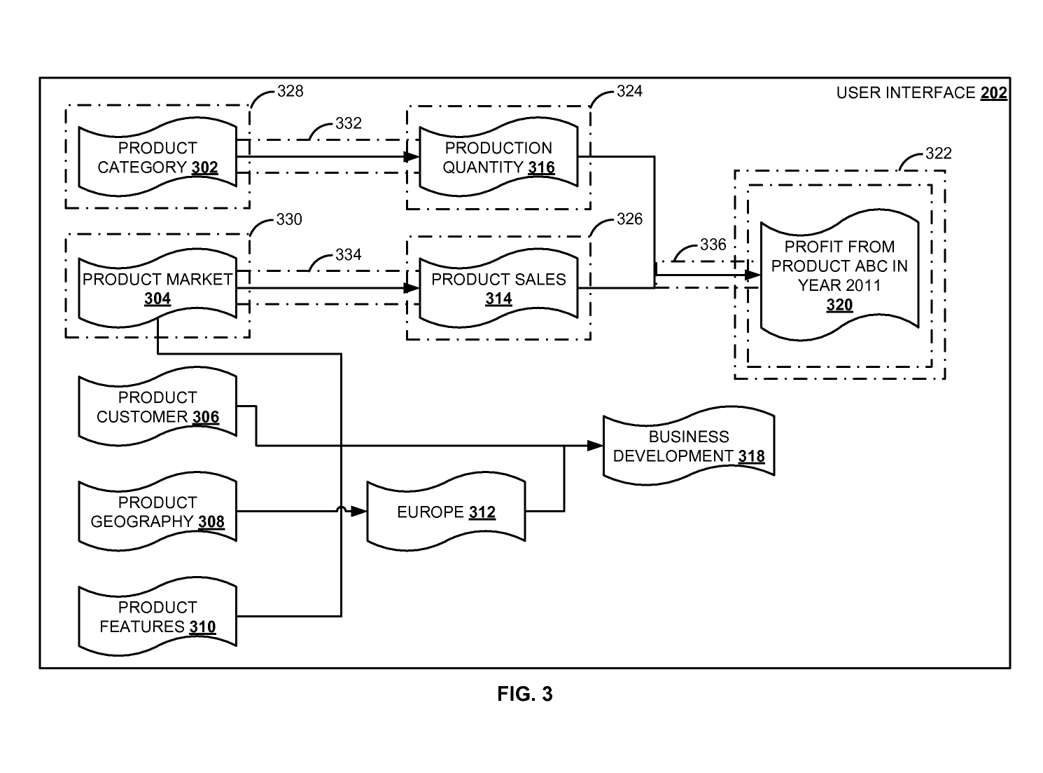

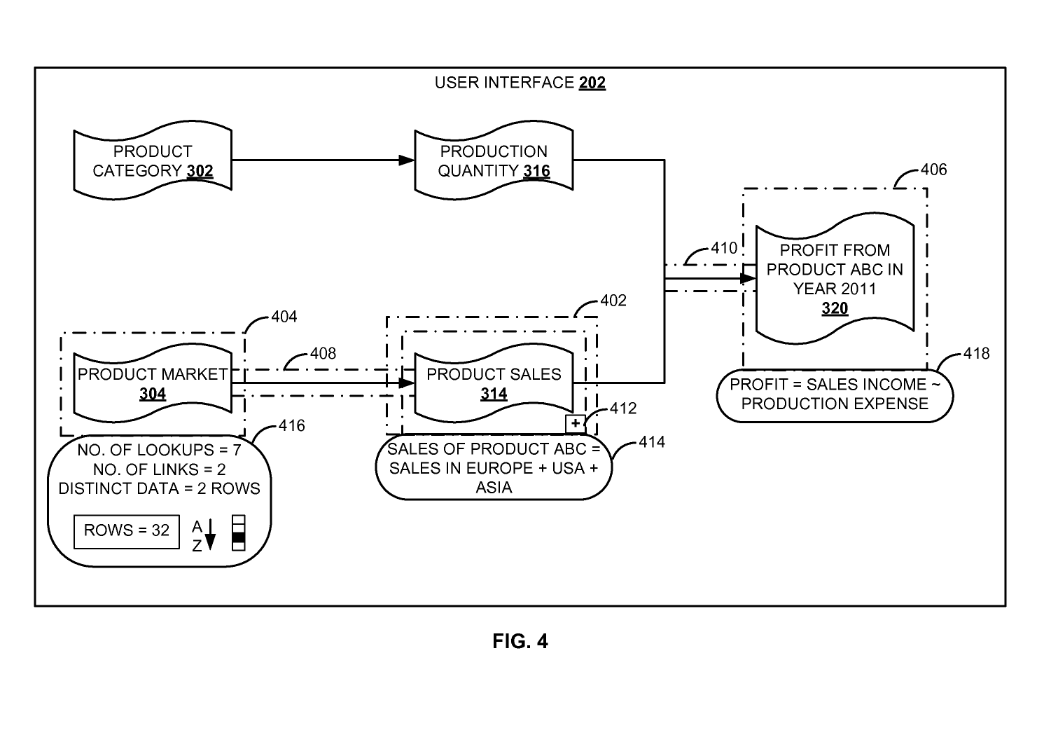

FIG. 3 and FIG. 4 are computer generated user interfaces illustrating a dataflow in an execution of a business process, according to an embodiment. From computer generated user interface (UI) 102, a selection of a UI element representing a corresponding business process element is received. The metadata of the selected UI element is retrieved from a database to determine associated business process elements. The associated business process elements are determined by identifying a lineage of an input to the business process element corresponding to the selected UI element, identifying a lineage of an output from the business process element corresponding to the selected UI element, and identifying a lineage of a transformation of data associated with the business process element corresponding to the selected UI element. Based upon the determination of the associated business process elements a visual representation of the dataflow involved in executing the business process is rendering on computer generated UI, represented by UI 202. In an embodiment, rendering the visual representation includes generating a comprehensive data tooltip corresponding to the selected UI element, along with the visual representation of the dataflow.

UI 202 of FIG. 3 displays UI elements 302, 304, 306, 308, 310, 312, 314, 316, 318 and 320. From UI 202 of FIG. 3, UI element 320 is selected that represents a corresponding business process element 320 PROFIT FROM PRODUCT ABC IN YEAR 2011. The metadata of UI element 320 is retrieved from database 148 to determine correlated business process elements. To identify the correlated business process elements, a lineage of an input to the business process element corresponding to UI element 320 is identified. UI element 320 is receiving input from UI elements 324 and 326; UI elements 324 and 326 are further receiving inputs from UI elements 302 and 304 respectively. Thus the lineage of input is identified as 302 and 304 to 316 and 314, further to 320 respectively. Further, a lineage of output from the business process element corresponding to UI element 314 is identified. In UI 202 of FIG. 3, the output of UI element 320 is not transmitted to any other UI element; hence, the lineage of output does not exist. A lineage of transformation of data associated with the business process element corresponding to selected UI element 320 is identified. The data associated with selected UI element 320 is the data that transformed data associated with the input lineage. Here, the product category information is derived from UI element 302, the market details of the product is derived from UI element 304 and production quantity and product sales are calculated in UI elements 316 and 314. Further, the calculated data in UI elements 316 and 314 is used to calculate to the profit from product ABC in year 2011 in UI element 320. By compiling the above information, the business process elements correlated with the business process element corresponding to UI element 320 are identified as UI elements 302, 304, 316 and 314.

Rendering visual representation on UI 202 of FIG. 3 includes highlighting the correlated UI elements 302, 304, 316 and 314 that are correlated to UI element 320; and/or highlighting the correlation between UI element 320 and the UI elements 302, 304, 316 and 314. The dataflow involved in executing UI element 320, which includes UI elements 302, 304, 314, 316 and 320 may be highlighted by changing a shape of the UI elements, changing a color of the UI elements, changing a pattern of lines that define the UI elements, or the like. UI 202 of FIG. 3 represents this visual identification by displaying dotted lines 328, 330, 324, 326 and 322 around the correlated UI elements 302, 304, 314, 316 and 320 respectively. The correlation between the UI elements is identified by displaying a dotted line 332, 334 and 336 around the connectors. Thus, the dataflow involved in the execution of the business process is visually rendered on the UI. The dataflow involved in the execution of the business process can be examined by analyzing the visual representation rendered on the computer generated UI.

UI 202 of FIG. 4 displays UI elements PRODUCT CATEGORY 302, PRODUCT QUANTITY 316, PRODUCT MARKET 304, PRODUCT SALES 314 and PROFIT FROM PRODUCT ABC IN YEAR 2011—320. From UI 202 of FIG. 4, UI element 314 is selected, that represents a corresponding business process element ‘product sales’. The metadata of UI element 314 is retrieved from the database, to determine associated business process elements. To identify the associated business process elements, a lineage of an input to the business process element corresponding to UI element 314 is identified. UI element 314 is receiving input from UI element 304; thus, the lineage of input is identified. A lineage of output from the business process element corresponding to UI element 314 is identified. UI element 320 is receiving output from the selected UI element 314; thus, the lineage of output is identified. A lineage of transformation of data associated with the business process element corresponding to selected UI element 314 is identified. The data associated with selected UI element 314 is the transformed data that is associated with UI element 304; thus, the lineage of the transformation is identified. By compiling the above information, the business process elements correlated with the business process element corresponding to UI element 314 are identified as UI element 304 and UI element 320.

Rendering the visual representation on UI 202 of FIG. 4 includes highlighting the correlated UI elements 304 and 320 that are correlated with UI element 314, and/or highlighting the correlation between UI element 314 and UI elements 304 and 320. The dataflow involved in executing UI element 314, which includes UI elements 304, 314 and 320 may be highlighted by changing a shape of the UI elements, changing a color of the UI elements, changing a pattern of lines that define the UI elements, or the like. UI 202 of FIG. 4 represents this visual identification by displaying a dotted line 402, 404 and 405 around the associated UI elements 304, 314 and 320. The correlation between the UI elements is identified by displaying a dotted line 408 and 410 around the connectors. Thus, the dataflow involved in the execution of the business process is visually rendered on the UI.

In an embodiment, a comprehensive data tooltip corresponding to the selected UI element is generated along with the visual representation. UI 202 of FIG. 4 displays comprehensive data tooltips 414, 416 and 418 to render a summary of associated UI elements 314, 304 and 320 respectively. The tooltips 414, 416 and 418 may be enabled or disabled to be rendered on UI 202 of FIG. 4. The tooltips may also be selectively enabled—by enabling selected tooltips; or globally enabled—by enabling all the tooltips to be displayed. The tooltips may be enabled by activating enable option 412 on associated with selected UI element 314, or an enable option associated with the business process elements. When a mouse pointer is hovered on 412 or any other UI area of the UI element that is operable to display the tooltip, the tooltip is displayed on UI 202 of FIG. 4. When the mouse pointer is moved from the UI area, the tooltip may disappear. The tooltips may be enabled to permanently appear along with the correlated UI elements upon the execution of the business process. When enabled, tooltip 414, 416 and 418 display textual information including alpha-numeric characters and/or graphical information including symbols, icons, formulae, business expressions and the like to provide a summary about the associated UI element. The tooltip may include a name or an identification of the UI element, a graphical representation of the identification of the UI element, information about the business process elements associated with the UI element, information about the data fields, the data field names, the database schemas, the database schema names, input lineage information, output lineage information, transformation information, hierarchical information, correlated business process elements' identification, mapping information, number of links or correlations with reference to a UI element, number of rows and number of columns included in each schema, a complexity indication of the UI element with reference to transformation, a complexity score, or the like. In an embodiment, the tooltip provides a comprehensive overview to understand the dataflow involved in the execution of the business process. In an embodiment, generating the tooltip includes generating a data analysis tooltip corresponding to each business process element that is involved in the execution of the business process. Here, the data analysis tooltip includes an overview of the transformations associated with the data corresponding to the selected UI element. The generated tooltip may include a correlation expression for the business process elements involved in the execution of the business process. In UI 202 of FIG. 4, tooltip 414 displays a formula used to calculate PRODUCT SALES 314; tooltip 416 displays a number of times the business process element was looked-up for, a number of links shared by the business process element, number of rows of the business process element having distinct data, a total number of rows, a ‘A-Z’ sort option, and a level of complexity indicated by a scale; tooltip 418 displays a formula used to calculate PROFIT FROM PRODUCT ABC IN YEAR 2011—320. The dataflow involved in the execution of the business process can be examined by analyzing the visual representation rendered on the computer generated UI.

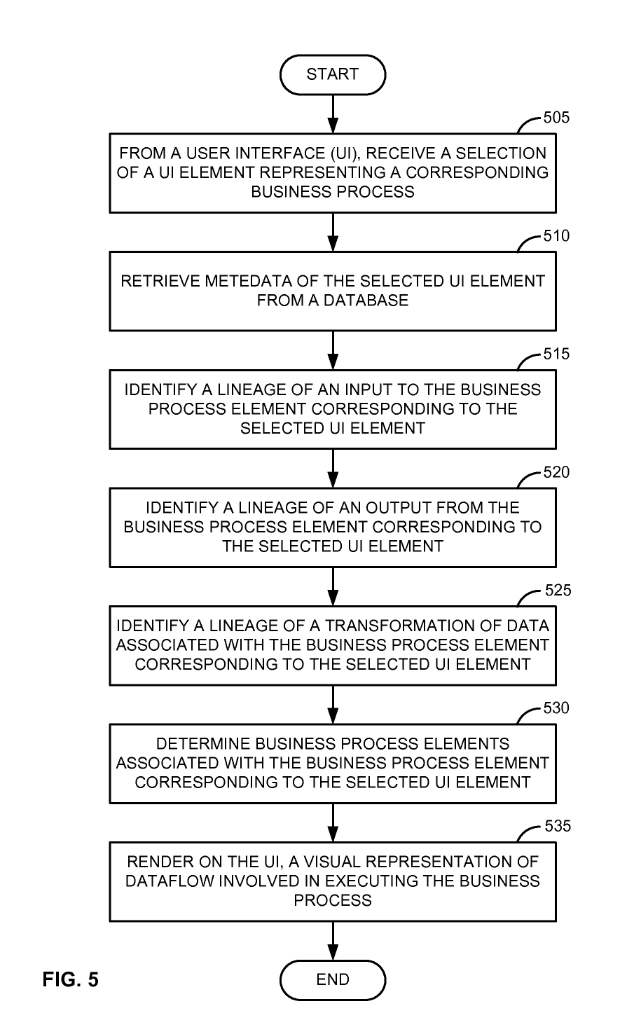

FIG. 5 is a process flow diagram illustrating a computer-implemented method to examine a dataflow in an execution of a business process, according to an embodiment. In an embodiment, the execution of the business process includes executing individual business process elements associated with the business process. The business process elements are entities of a business processor, and include business information of the corresponding business process. In an embodiment, the business process elements represent a subset of the business process. The business process elements are available to a user as user interface (UI) elements on a computer generated UI. In an embodiment, the business process elements represent backend information of the corresponding UI elements present on the UI. At process block 505, a selection of a UI element representing a corresponding business process is received from a computer generated UI. At process block 510, metadata of the selected UI element is retrieved from a database. The metadata of the selected UI element includes information about the corresponding process element of the selected UI element, database schemas and associated data fields of the selected UI element. Retrieving the metadata includes retrieving the information corresponding to the selected UI element.

At process block 515 a lineage of an input to the business process element corresponding to the selected UI element is identified. Identifying the lineage of the input to the selected UI includes identifying a source of input (data source) for the selected UI. For instance, the input to the selected UI element may be received from a preceding business process element, a combination of one or more preceding business process elements, or may be contained in the business process element corresponding to the UI element. Here, the element that provides the input to the selected UI element represents the source of input. In an embodiment, the business process element corresponding to the selected UI element is correlated with other business process elements involved in the execution of the business process is determined. In another embodiment, the business process element corresponding to the selected UI element exists in a hierarchy of a plurality of business process elements involved in the execution of the business process. Based upon the hierarchy, a correlation between the business process element corresponding to the selected UI element and one or more business process elements involved in the execution of the business process are determined. To identify the lineage of the input to the business process element corresponding to the selected UI element, the hierarchy including the corresponding business process element is identified. Further, the correlated business process elements preceding the selected UI element in the hierarchy are identified. Inheritances of attributes from the preceding business process elements to the selected UI element are identified. Based upon one or more of the above factors, the lineage of the input to the business process corresponding to the selected UI element is identified.

At process block 520, a lineage of an output from the business process element corresponding to the selected UI element is identified. Identifying the lineage of the output from the selected UI includes identifying a target of output for the selected UI. For instance, the output of the selected UI element may be transmitted to a succeeding business process element, a combination of one or more succeeding business process elements, or may be final destination or a target business process element corresponding to the UI element. Here, the element that receives the output of the selected UI element represents the destination of data. In an embodiment, correlated business process elements that are succeeding the selected UI element in the hierarchy are identified. Further, a transmission of one or more attributes from the selected UI element to the succeeding correlated business process elements are identified. Based upon the identification, the lineage of the output from the business process element corresponding to the selected UI element is identified.

At process block 525, a lineage of transformation of data associated with the business process element corresponding to the selected UI is identified. Identifying the lineage of the transformation of the data associated with the selected UI element includes identifying if the associated data has undergone any transformation from its previous condition, status or representation. For instance, an output of a first business process element may represent a manufactured quantity of product XYZ, this information may be used by a second business process to calculate a sales of product XYZ. The information from the first business process element may be transformed accordingly to calculate the sales of the product XYZ at the second business process element. Further, in a third business process element, the sales information of the product XYZ may be further transformed to calculate a profit from sales of product XYZ for a period of six months. A lineage of transformation of information associated with the third business process element involves identifying the lineage of the transformation of information from all correlated business process elements (for e.g. first business process element and second business process element). To identify a lineage of transformation of data associated with the selected UI element, the data present in the business process element corresponding to the selected UI element is identified. Further, a correlation between the data present in the business process element corresponding to the selected UI element and one or more business process elements correlated to the selected UI is identified. For instance, the correlation between the data present in the first business process element and the second business process element in the above example may include a mathematical formula to calculate the sales of product XYZ from the manufactured quantity. Similarly, the correlation between the data present in the second business process element and the third business process element may include a mathematical formula to calculate a profit obtained from the sales of product XYZ. Based upon the correlation, the transformation of the data associated with the business process element corresponding to the selected UI element is identified. In an embodiment, identifying a lineage of the transformation of data includes identifying a correlation between one or more data fields corresponding to the selected UI element and one or more data fields associated with one or more business process elements involved in the execution of the business process.

At process block 530, one or more business process elements associated with the business process element corresponding to the selected UI element are determined. The business process elements associated with the business process element corresponding to the selected UI element may be determined by determining the lineage of the input to the selected UI element, the lineage of the output from the selected UI element and the lineage of transformation of data associated with the selected UI element. In an embodiment, determining associated business process elements includes determining database schemas related to the business process element corresponding to the selected UI element and database schemas related to the associated business process elements. Determining associated business process elements may also include determining data fields included in each database schema related to the business process element corresponding to the selected UI element and database schemas related to the associated business process elements. A correlation between the data fields of the database schema related to the business process element corresponding to the selected UI element and database schemas related to the associated business process elements are determined to determine the associated business process elements. Based upon the correlation, the transformation of data present in the data fields is determined.

At process block 535, based upon the determination of the correlated business process elements, a visual representation of the dataflow involved in executing the business process is rendered on the UI. In an embodiment, rendering the visual representation of the dataflow includes highlighting the correlation between the selected UI element and other correlated UI elements corresponding to the business process elements. Highlighting the correlation further includes highlighting the correlation between the selected UI element and the correlated UI elements that represent one or more business process-steps preceding the selected UI element and highlighting the correlation between the selected UI element and the correlated UI elements that represent one or more business process-steps succeeding the selected UI element. The business process-steps preceding the selected UI element represent the execution of the business process from a source of data to the current business process element corresponding to the selected UI element. The business process-steps succeeding the selected UI element represent the execution of the business process from the current business process element corresponding to the selected UI element to a destination of data.

In an embodiment, highlighting the correlation includes highlighting one or more UI elements that are involved in executing the business process. These highlighted UI elements include elements that share a correlation with the selected UI element. Hence, highlighting the correlation includes highlighting an input to one or more business process elements associated with the selected UI element, highlighting an output from the business process elements associated with the selected UI element, and highlighting one or more transformation of the business process elements associated with the selected UI element, that are involved during the execution of the business process. Highlighting the correlation also includes highlighting one or more succeeding UI elements involved in the execution of the business process when the selected UI element corresponds to an initial business process element and highlighting one or more preceding UI elements involved in the execution of the business process when the selected UI element corresponds to a final business process element.

In an embodiment, rendering a visual representation includes generating a comprehensive data tooltip corresponding to the selected UI element or the associated UI elements (corresponding to the correlated business process elements), along with the visual representation of the dataflow. A comprehensive data tooltip rendered on the computer generated UI includes comprehensive information or a summary of the associated UI element. The comprehensive data tooltip may be enabled or disabled to be rendered on the computer generated UI along the visual representation of the data flow of the execution of the business process. The tooltip may be enabled by activating an enable option on the computer generated UI, or an enable option associated with the business process elements. For instance, when a computer cursor is hovered on a certain UI area of the UI element, the tooltip may be displayed on the computer generated UI. When the computer cursor is moved from the UI area, the tooltip may disappear. When enabled, the tooltip may display textual information including alpha-numeric characters and/or graphical information including symbols, icons and the like to provide a summary about the associated UI element. The tooltip may include a name or an identification of the UI element, a graphical representation of the identification of the UI element, information about the business process elements associated with the UI element, information about the data fields, the data field names, the database schemas, the database schema names, input lineage information, output lineage information, transformation information, hierarchical information, correlated business process elements' identification, mapping information, number of links or correlations with reference to a UI element, number of rows and number of columns included in each schema, a complexity indication of the UI element with reference to transformation, a complexity score, or the like. In an embodiment, the tooltip provides a comprehensive overview to understand the dataflow involved in the execution of the business process. In an embodiment, generating the tooltip includes generating a data analysis tooltip corresponding to each business process element that is involved in the execution of the business process. Here, the data analysis tooltip includes an overview of the transformations associated with the data corresponding to the selected UI element. The generated tooltip may include a correlation expression for the business process elements involved in the execution of the business process. The dataflow involved in the execution of business process can be examined by analyzing the visual representation rendered on the computer generated UI.

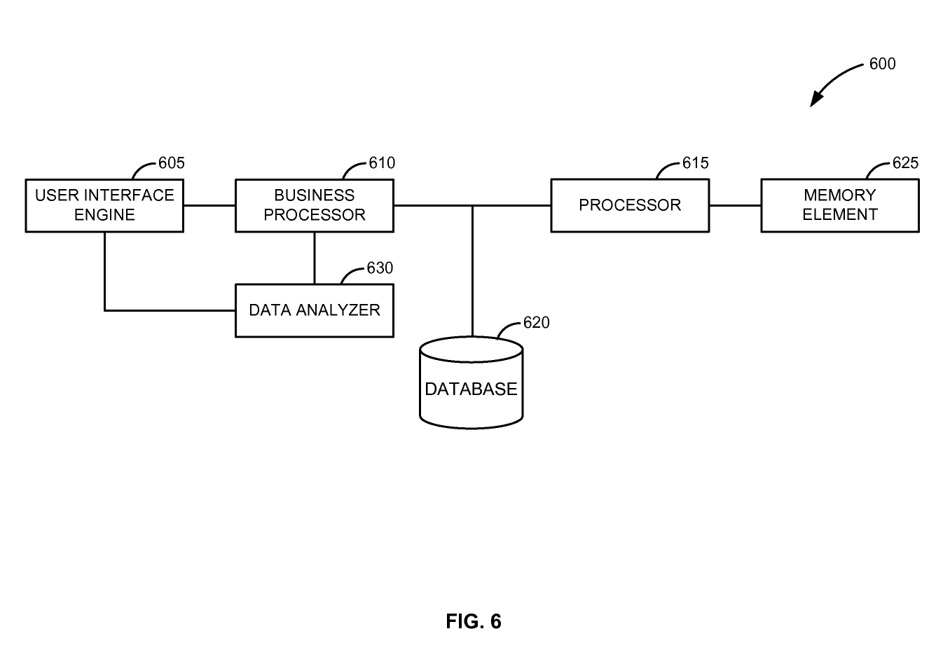

FIG. 6 is a block diagram illustrating a computer system to examine a dataflow in an execution of a business process, according to an embodiment. Computer system 600 includes user interface (UI) engine 605, business processor 610, processor 615, database 620, memory element 625 and data analyzer 630. In an embodiment, UI engine 605 is in communication with business processor 610 and data analyzer 630. Business processor 610 is in communication with data analyzer 630, database 620 and processor 615 of computer system 600. In an embodiment, processor 615 is configured to read and execute instructions stored in memory element 625.

A computer generated UI in communication with UI engine 605 displays one or more UI elements associated with the execution of one or more business processes. In an embodiment, to examine a dataflow in the execution of a business process, a UI element associated with the corresponding business process is selected on the computer generated UI. UI engine 605 recognizes and receives the selection of the UI element that represents a corresponding business process element. In an embodiment, each UI element has a corresponding business process element that represents associated business information to business processor 610. Business processor 610 retrieves metadata of the selected UI element from database 620, and determines one or more business process elements that are associated with the business process element corresponding to the selected UI element. To determine the one or more business process elements associated with the business process element corresponding to the selected UI element, business processor 610 determines an input lineage, an output lineage and a transformation lineage associated with the selected UI element.

The input lineage is determined by identifying a lineage of an input to the business process element corresponding to the selected UI element. The input lineage corresponding to the selected UI element may represent ancestry of one or more data sources from which business data is extracted and transformed depending upon a business requirement, and loaded to the selected UI element as an input. Identifying the lineage of the input includes identifying a hierarchy of one or more business process elements involved in the execution of the business process. Depending upon a position of the business process element corresponding to the selected UI element in the hierarchy, one or more preceding business process elements that are correlated with the selected UI element are identified. Further, inheritance of one or more attributes from the correlated preceding business process elements is identified. By compiling one or more of the above information, the lineage of the input to business process element corresponding to the selected UI element is identified.

The output lineage is determined by identifying a lineage of the output from the business process element corresponding to the selected UI element. The output lineage corresponding to the selected UI element may represent posterity of one or more data destinations to which the output of the selected UI element is loaded as an input. Identifying the lineage of the output includes identifying the hierarchy of one or more business process elements involved in the execution of the business process. Depending upon a position of the business process element corresponding to the selected UI element in the hierarchy, one or more succeeding business process elements that are correlated with the selected UI element are identified. Further, transmission of one or more attributes from the selected UI to the correlated succeeding business process elements is identified. By compiling one or more of the above information, the lineage of the output from business process element corresponding to the selected UI element is identified.

The transformation lineage is determined by identifying a lineage of transformation of data associated with the business process element corresponding to the selected UI element. The transformation lineage corresponding to the selected UI element may represent an ancestry and a posterity of one or more transformations of the data associated with the selected UI element. Identifying the lineage of the transformation includes identifying the data present in the business process element corresponding to the selected UI element. A correlation between the data present in the business process element corresponding to the selected UI element and the one or more business process elements involved in the execution of the business process is identified. Based upon the correlation, the transformation of the data associated with the business process element corresponding to the selected UI element is identified.

Based upon the determined one or more business process elements associated with the business process element corresponding to the selected UI element, dataflow analyzer 630 analyzes the flow of data involved in the execution of the business process, and renders on the computer generated UI, a visual representation of the dataflow. In an embodiment, rendering a visual representation of the dataflow includes highlighting a correlation between the selected UI elements and correlated UI elements, highlighting one or more correlated UI elements, highlighting the input and output associated with the selected UI element, highlighting the transformations associated with the selected UI element, and highlighting one or more UI elements preceding and/or succeeding the selected UI element that are involved in the execution of the business process along with the selected UI element. The correlated UI elements are UI representations of the correlated business process elements that are correlated with the business process element corresponding to the selected UI element.

In an embodiment, each business process element is associated with one or more database schemas and one or more data fields included in the database schemas. Here, determining the associated business process elements include determining the database schemas and determining the data fields included in each database schema related to the business process element corresponding to the selected UI element and other associated business process elements. A correlation between one or more data fields of the database schemas related to the business process element corresponding to the selected UI element and other associated business process elements is determined. Based upon the correlation between the data fields, one or more transformations of the data present in the data fields are determined.

In another embodiment, rendering a visual representation of the dataflow includes generating a comprehensive data tooltip corresponding to the selected UI element, along with the visual representation of the dataflow. The comprehensive data tooltip may include information rendered from one or more data field names, one or more database schema names, one or more business process element names, one or more lineage information, one or more transformation information, one or more hierarchical information, and one or more correlated business process element names. Generating the comprehensive data tooltip may include generating a data analysis tooltip corresponding to each business process element involved in the execution of the business process. The data analysis tooltip includes an overview of one or more transformations associated with the data present corresponding to the selected UI element. Generating the comprehensive tooltip may also include generating a correlation expression for the business process elements involved in the execution of the business process.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

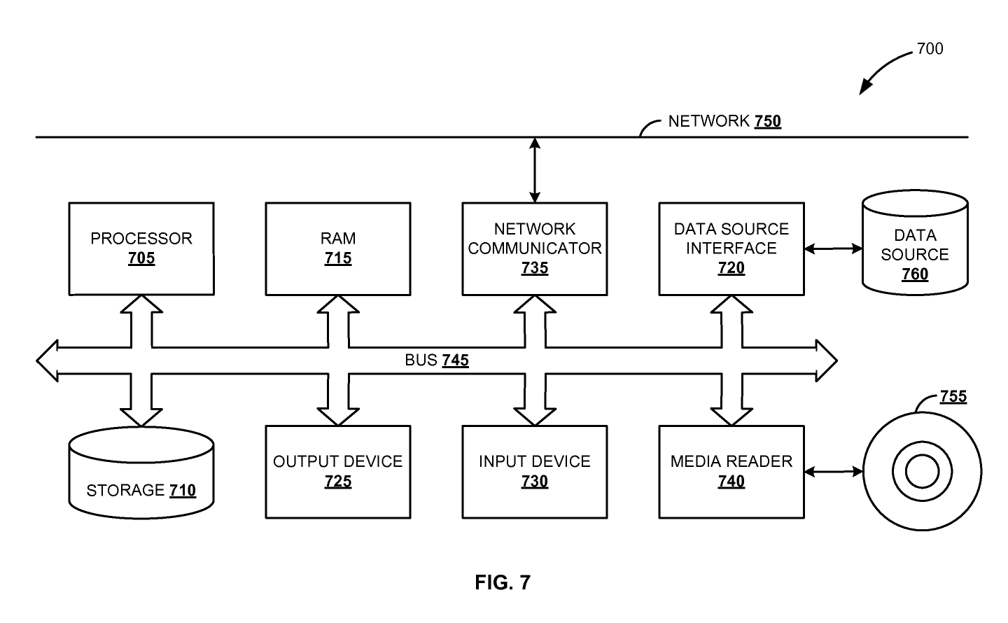

FIG. 7 is a block diagram illustrating an exemplary computer system 700, according to an embodiment. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes an output device 725 (e.g., a display) to provide at least some of the results of the execution as output including, but not limited to, visual information to users and an input device 730 to provide a user or another device with means for entering data and/or otherwise interacting with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, continuation servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transaction, hierarchical, multi-dimensional (e.g., OLAP), object oriented databases, and the like. Further data sources include tabular data (e.g., spreadsheets, delimited text files), data tagged with a markup language (e.g., XML data), transaction data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method to examine a dataflow in an execution of a business process, comprising:
receiving, from a computer generated user interface (UI), a selection of a UI element representing a business process element;
a processor of the computer retrieving metadata of the selected UI element from a database, to determine one or more business process elements that are associated with the business process element corresponding to the selected UI element by—
identifying a lineage of an input to the business process element corresponding to the selected UI element,
identifying a lineage of an output from the business process element corresponding to the selected UI element, and
identifying a lineage of a transformation of data associated with the business process element corresponding to the selected UI element; and
based upon the determination of the associated business process elements, rendering on the computer generated UI, a visual representation of the dataflow related to executing the business process.

2. The computer implemented method of claim 1, wherein retrieving the metadata of the selected UI element comprises:
retrieving information about the corresponding business process element of the selected UI element;
retrieving one or more database schemas related to the selected UI element; and
retrieving one or more fields included in each database schema related to the selected UI element.

3. The computer implemented method of claim 1, wherein determining the business process elements comprises: determining a correlation between the business process element corresponding to the selected UI element and one or more business process elements involved in the execution of the business process.

4. The computer implemented method of claim 1, wherein identifying a lineage of the input to the business process element corresponding to the selected UI element comprises:
identifying a hierarchy of one or more business process elements involved in the execution of the business process;
identifying one or more preceding business process elements correlated with the selected UI element; and
identifying an inheritance of one or more attributes from one or more correlated preceding business process elements to the selected UI element.

5. The computer implemented method of claim 1, wherein identifying a lineage of the output from the business process element corresponding to the selected UI element comprises:
identifying the hierarchy of one or more business process elements involved in the execution of the business process;
identifying one or more succeeding business process elements correlated with the selected UI element; and
identifying a transmission of one or more attributes from the selected UI element to one or more correlated succeeding business process elements.

6. The computer implemented method of claim 1, wherein identifying a lineage of the transformation of data associated with the business process element corresponding to the selected UI element comprises:
identifying the data present in the business process element corresponding to the selected UI element;
identifying a correlation between the data present in the business process element corresponding to the selected UI element and one or more business process elements involved in the execution of the business process;
based upon the correlation, identifying one or more transformation of the data associated with the business process element corresponding to the selected UI element.

7. The computer implemented method of claim 1, wherein identifying a lineage of the transformation of data comprises:
identifying a correlation between one or more data fields corresponding to the selected UI element and one or more data fields associated with one or more business process elements involved in the execution of the business process;
based upon the correlation, rendering a visual representation of the dataflow representing one or more transformations of data present in the data fields corresponding to the selected UI element.

8. The computer implemented method of claim 1 further comprising:
receiving a selection of a UI element involved in the execution of the business process;
determining one or more UI elements that are correlated to the selected UI element; and
highlighting the correlation between the selected UI element and correlated UI elements.

9. The computer implemented method of claim 8, wherein highlighting the correlation comprises:
highlighting the correlation between the selected UI element and the correlated UI elements that represent one or more business process-steps preceding the selected UI element; and
highlighting the correlation between the selected UI element and the correlated UI elements that represent one or more business process-steps succeeding the selected UI element.

10. The computer implemented method of claim 8, wherein highlighting the correlation comprises: highlighting one or more UI elements that are involved in executing the business process.

11. The computer implemented method of claim 8, wherein highlighting the correlation comprises:
highlighting an input to one or more business process elements associated with the selected UI element,
highlighting an output of the business process elements associated with the selected UI element, and
highlighting one or more transformation of the business process elements associated with the selected UI element, that are involved during the execution of the business process.

12. The computer implemented method of claim 8, wherein highlighting the correlation comprises:
highlighting one or more succeeding UI elements involved in the execution of the business process when the selected UI element corresponds to an initial business process element; and
highlighting one or more preceding UI elements involved in the execution of the business process when the selected UI element corresponds to a final business process element.

13. The computer implemented method of claim 1, wherein determining the associated business process elements comprise:
determining one or more database schemas related to—
the business process element corresponding to the selected UI element, and
the associated business process elements;
determining one or more data fields included in each database schema related to—
the business process element corresponding to the selected UI element, and
the associated business process elements; and
determining a correlation between one or more data fields of the database schema related to—
the business process element corresponding to the selected UI element, and
the associated business processes.

14. The computer implemented method of claim 13 further comprising: based upon a correlation between one or more data fields, determining one or more transformations of data present in the data fields.

15. The computer implemented method of claim 1 further comprising: generating a comprehensive data tooltip corresponding to the selected UI element along with the visual representation of the dataflow.

16. The computer implemented method of claim 15, wherein generating the comprehensive data tooltip includes:
generating a data analysis tooltip corresponding to each business process element involved in the execution of the business process, wherein the data analysis tooltip includes an overview of one or more transformations associated with the data present corresponding to the selected UI element.

17. The computer implemented method of claim 15, wherein the comprehensive data tooltip includes information rendered from a group comprising: one or more data field names, one or more database schema names, one or more business process element names, one or more lineage information, one or more transformation information, one or more hierarchical information, and one or more correlated business process element names.

18. The computer implemented method of claim 15, wherein generating the comprehensive tooltip includes: generating a correlation expression for the business process elements involved in the execution of the business process.

19. A computer system to examine a dataflow in an execution of a business process, comprising:
a processor configured to read and execute instructions stored in one or more memory elements; and
the one or more memory elements storing instructions to—
a user interface (UI) engine to receive a selection of a UI element representing a business process element, from a computer generated UI;
a business processor to retrieve metadata of the selected UI element from a database and determine one or more business process elements that are associated with the business process element corresponding to the selected UI element by—
identifying a lineage of an input to the business process element corresponding to the selected UI element,
identifying a lineage of an output from the business process element corresponding to the selected UI element, and
identifying a lineage of a transformation of data associated with the business process element corresponding to the selected UI element; and
a dataflow analyzer to render on the computer generated UI, a visual representation of the dataflow involved in executing the business process, based upon the determination of the one or more business process elements.

20. An article of manufacture including a non-transitory computer readable storage medium to tangibly store instructions, which when executed by a computer, cause the computer to:
receive, from a computer generated user interface (UI), a selection of a UI element representing a business process element;
retrieve metadata of the selected UI element from a database, and determine one or more business process elements that are associated with the business process element corresponding to the selected UI element by—
identifying a lineage of an input to the business process element corresponding to the selected UI element,
identifying a lineage of an output from the business process element corresponding to the selected UI element, and
identifying a lineage of a transformation of data associated with the business process element corresponding to the selected UI element; and
based upon the determination of the associated business process elements, render on the computer generated UI, a visual representation of the dataflow involved in executing the business process.
